(19) United States
(12) Patent Application Publication
(10) Pub. No.: US 2024/0245086 A1
(43) Pub. Date: Jul. 25, 2024

(54) RAPID ONSET CANNABINOID COMPOSITIONS

(71) Applicant: PAX LABS, INC., San Francisco, CA (US)

(72) Inventor: Richard RUCKER, San Francisco, CA (US)

(21) Appl. No.: 18/421,313

(22) Filed: Jan. 24, 2024

Related U.S. Application Data
(60) Provisional application No. 63/440,806, filed on Jan. 24, 2023.

(51) Int. Cl. A23L 29/00; A23L 2/38; A23L 2/395; A23L 2/60

(52) U.S. Cl. CPC A23L 29/035; A23L 2/38; A23L 2/395; A23L 2/60

(57) ABSTRACT

The present application describes cannabis formulations for oral ingestion that provide rapid onset time of cannabinoid effects. The cannabinoid formulations can be in solid form (e.g., tablet or powder) or liquid form (e.g., beverage or tincture). In certain embodiments, the solid composition is intended to be ingested directly into the user's mouth, such as on or under the tongue. In other embodiments, the solid composition is intended to be dissolved in a liquid, such as water or another beverage, prior to consumption.

### CROSS-REFERENCE TO RELATED APPLICATION

The present application claims the benefit of U.S. Provisional Patent Application No. 63/440,806, filed on Jan. 24, 2023 and titled “Rapid Onset Cannabinoid Compositions” the entire contents of which is incorporated herein by reference in its entirety.

### BACKGROUND OF THE INVENTION

Oral ingestion has become one of the primary delivery methods for cannabis products and cannabinoid formulations. Such consumption can be in the form of edible food products, beverages, tablets that can be chewed, tablets or powders that can be dissolved in the mouth, dissolved in a liquid, and the like. While ingestion that involves smoking or inhalation typically has an onset time for effects of the cannabinoid product in the range of just a few minutes or less, oral ingestion typically provides onset times in the range of 15 minutes or more, often not providing peak effect until 60 minutes or more after ingestion.

As such, there remains a need for orally-ingested cannabinoid formulations with improved onset times. The present application describes cannabinoid formulations that address these needs.

### SUMMARY OF THE INVENTION

The present application describes cannabis formulations for oral ingestion that provide decreased onset time of cannabinoid effects.

The formulations and compositions described herein include one or more cannabinoids. In certain embodiments, the formulation comprises tetrahydrocannabinol (THC). In other embodiments, the composition comprises cannabidiol (CBD). In further embodiments, the composition comprises both THC and CBD.

In certain embodiments, the composition is a solid composition comprising one or more cannabinoids. In particular embodiments, the solid composition is a tablet. In other embodiments, the solid composition is a powder. In certain embodiments, the solid composition is intended to be ingested directly into the user's mouth, such as on or under the tongue. In certain embodiments, the solid composition, when dissolved in the mouth or in water, provides a basic pH, i.e., a pH greater than 7.0, preferably greater than about 7.2, 7.4, 7.5, 7.6, 7.8, 8.0, or more. In other embodiments, the solid composition, when dissolved in the mouth or in water, provides a pH of about 7.2, 7.5, 8.0, 8.5, or 9.0.

In certain embodiments, the present application describes a beverage composition, wherein the beverage composition is produced by dissolving a cannabis formulation as described herein in a liquid prior to consumption. In particular embodiments, the solid composition is dissolved in 2-20 ounces of liquid prior to consumption, preferably 2-16, 2-12, 2-10, 2-8, 2-6, or 3-5 ounces of liquid prior to consumption. In certain embodiments, the liquid into which the cannabis formulation is dissolved is basic, i.e., it comprises a pH >7.0. In particular examples, the liquid into which the cannabis formulation is dissolved comprises a pH of greater than about 7.2, 7.4, 7.5, 7.6, 7.8, 8.0, or more. In particular example, the liquid into which the cannabis formulation is dissolved comprises a pH of about 7.5-8.5, preferably 7.75-8.25, more preferable about 8.0.

In certain embodiments, the solid composition comprises one or more effervescent agents such that the composition effervesces during and/or after dissolution.

In other embodiments, the composition is a liquid composition comprising one or more cannabinoids. In particular embodiments, the liquid composition is basic, i.e., it possesses a pH >7.0.

To achieve the desired pH, the composition generally includes an acid component, an alkali (or base) component, or, in many instances, both. In certain embodiments, the acid component includes one or more of citric acid, malic acid, tartaric acid, ascorbic acid, fumaric acid, maleic acid, and/or succinic acid. In certain embodiments, the alkali/base component includes one or more of sodium carbonate, sodium bicarbonate, sodium glycine carbonate, calcium carbonate, potassium carbonate, and/or potassium bicarbonate. In certain examples, the solid composition includes citric acid and sodium carbonate. In still further examples, the solid composition comprises citric acid and sodium carbonate in a ratio sufficient to provide a pH of 7.5-8.5 upon dissolution in water, preferably 7.75-8.25, more preferably about 8.0. In additional embodiments, the acid and base component provide for effervescence upon dissolution of the solid composition in a liquid, such as water.

In certain embodiments the composition further comprises one or more additional components, such as flavorants (e.g., an essential oil or natural or artificial flavor), colorants (e.g., a natural or artificial color), and/or sweeteners (e.g., a natural or artificial sweetener). In further embodiments, the composition may include additional excipients, including but not limited to one or more diluents (also referred to as bulking agents or fillers), binders, granulating agents, glidants, lubricants, and/or disintegrants.

In certain embodiments, onset of cannabinoid effects following oral ingestion of the formulations will begin in about 30 minutes, 25 minutes, 20 minutes, 15 minutes, 10 minutes, 5 minutes, or less. In other embodiments, peak cannabinoid effects will be reached in about 50 minutes, 45 minutes, 40 minutes, 35 minutes, 30 minutes, 25, minutes, 20 minutes, 15 minutes, 10 minutes, or less.

### BRIEF DESCRIPTION OF THE DRAWINGS

FIG. 1 illustrates self-reported results of subjects after consuming THC-containing powder formulations as described herein.

FIG. 2 illustrates physiological monitoring results of subjects after consuming THC-containing powder formulations as described herein.

### DETAILED DESCRIPTION

It is to be understood that this disclosure is not limited to particular embodiments, which can, of course, vary. It is also to be understood that the terminology used herein is for the purpose of describing particular embodiments only, and is not intended to be limiting. Unless defined otherwise, all technical and scientific terms used herein generally have the same meaning as commonly understood by one of ordinary skill in the art to which this disclosure belongs.

As used in this specification and the appended claims, terms in the singular and the singular forms “a,” “an,” and “the,” for example, include plural referents unless the content clearly dictates otherwise. Thus, for example, reference to “weight,” “the weight” or “a weight” also includes a plurality of weights. Additionally, as used herein, the term “comprises” is intended to indicate a non-exhaustive list of components or steps, thus indicating that the given composition or method includes the listed components or steps and may also include additional components or steps not specifically listed. As an example, a formulation “comprising THC” may also include additional components, such as CBD, terpenes, buffering components, etc. The term “comprising” is also intended to encompass embodiments “consisting essentially of” and “consisting of” the listed components or steps. Similarly, the term “consisting essentially of” is also intended to encompass embodiments “consisting of” the listed components or steps.

Numeric ranges recited within the specification and claims are inclusive of the numbers defining the range (the end point numbers) and also are intended to include each integer or any non-integer fraction within the defined range. Further, as used herein, the term “about” refers to a number that differs from the given number by less than 10%. In other embodiments, the term “about” indicates that the number differs from the given number by less than 9%, 8%, 7%, 6%, 5%, 4%, 3%, 2%, or 1%.

As discussed herein, “cannabinoid effects” means the effects caused by the particular cannabinoid that has been ingested. Cannabinoid effects can include the psychoactive effects typically associated with ingestion of THC, including dopamine release, increased heart rate, increased blood pressure, feelings of pleasure, feelings of relaxation, and/or altered senses. Cannabinoid effects can also include the medicinal effects typically associated with ingestion of CBD, including reduced feelings of anxiety or depression, decreased pain, and/or drowsiness.

The present inventors have developed novel cannabinoid formulations that provide for decreased onset time of cannabinoid effects when ingested orally, such as by direct ingestion of solid composition (e.g., tablet or powder), ingestion of a liquid into which a solid composition has been dissolved, or direct ingestion of a liquid composition (e.g., a beverage).

The formulations and compositions described herein include one or more cannabinoids. In certain embodiments, the formulation comprises tetrahydrocannabinol (THC), such as delta-9-THC or delta-8-THC. In particular embodiments, the formulation comprises delta-9-THC. In other embodiments, the composition comprises cannabidiol (CBD).

In other embodiments, the composition comprises more than one cannabinoid. In certain example, the composition comprises both THC and CBD. In particular embodiments, the composition comprises THC and CBD in a ratio between about 1:50 and 50:1, such as a ratio of about 1:50, 1:49, 1:48, 1:47, 1:46, 1:45, 1:43, 1:42, 1:41, 1:40, 1:39, 1:38, 1:37, 1:36, 1:35, 1:34, 1:33, 1:32, 1:31, 1:30, 1:29, 1:28, 1:27, 1:26, 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1, 31:1, 32:1, 33:1, 34:1, 35:1, 36:1, 37:1, 38:1, 39:1, 40:1, 41:1, 42:1, 43:1, 44:1, 45:1, 46:1, 47:1, 48:1, 49:1, or 50:1. In further embodiments, the composition comprises minor cannabinoids, such as CBG or CBN, optionally in combination with THC and/or CBD.

In certain embodiments, the cannabinoid is a liquid that is plated onto a solid “plating” material for preparation of a solid composition. In particular examples, the cannabinoid is a liquid cannabinoid extract or liquid synthetic cannabinoid. In particular examples, the cannabinoid is a THC or CBD distillate. In further examples, the cannabinoid is blended with another liquid prior to plating on the plating material, such as MCT oil. In certain examples, the plating material is silicon dioxide powder.

In certain embodiments, the cannabinoid is present in the final formulation in an amount of about 1-200 mg. In certain examples, the cannabinoid is present in the final formulation in an amount of about 1-100 mg, 2-75 mg, 2.5-50 mg, 3-30 mg, 4-20 mg, 5-15 mg, or 5-10 mg. In other examples, the cannabinoid is present in the final formulation in an amount if about 1, 2, 2.5, 3, 4, 5, 6, 7, 8, 9, 10, 11, 12, 13, 14, 15, 20, 25, 30, 35, 40, 45, 50, 55, 60, 65, 70, 75, 80, 85, 90, 95, 100, 110, 120, 130, 140, 150, 175, or 200 mg.

In other embodiments, the plating material containing the cannabinoid comprises about 2-25 weight percent of the final formulation. In particular examples, the plating material containing the cannabinoid comprises about 2-20, 2-15, 2-10, 3-9, 4-8, or 5-7 weight percent of the final formulation. In other particular examples, the plating material containing the cannabinoid comprises about 2, 3, 4, 5, 6, 7, 8, 9 10, 11, 12, 13, 14, 15, 16, 17, 18, 19, 20, 21, 22, 23, 24, or 25 weight percent of the final formulation.

In certain embodiments, the composition is a solid composition. In particular embodiments, the solid composition is a tablet. In other embodiments, the solid composition is a powder. In certain embodiments, the solid composition is intended to be ingested directly into the user's mouth, such as on or under the tongue. In particular embodiments, the solid composition will be allowed to partially, nearly completely, or completely dissolve in the mouth prior to swallowing. In other embodiments, the solid composition is intended to be dissolved in a liquid, such as water or another beverage, prior to consumption.

In certain embodiments, the solid composition, when dissolved in the mouth or in water, provides a pH of greater than about 7.2, 7.4, 7.5, 7.6, 7.8, 8.0, 8.2, 8.4, 8.5, 8.6, 8.8, 9.0, 9.2, 9.4, 9.5, 9.6, 9.8, or 10.0. In other embodiments, the solid composition, when dissolved in the mouth or in water, provides a pH of about 7.2, 7.4, 7.5, 7.6, 7.8, 8.0, 8.2, 8.4, 8.5, 8.6, 8.8, 9.0, 9.2, 9.4, 9.5, 9.6, 9.8, or 10.0.

In certain embodiments, the present application describes a beverage composition, wherein the beverage composition is produced by dissolving a cannabinoid formulation as described herein in a liquid prior to consumption. In particular embodiments, the liquid into which the cannabinoid formulation is dissolved is water. In other embodiments, the liquid into which the cannabinoid formulation is dissolved is itself a water-based beverage. In particular embodiments, the water based-beverage comprises one or more flavorants and/or one or more sweeteners.

In particular embodiments, the solid composition is dissolved in 2-20 ounces of liquid prior to consumption. In certain embodiments, the solid composition is dissolved in 2-16, 2-12, 2-10, 2-8, 2-6, or 3-5 ounces of liquid prior to consumption. In particular embodiments, the solid composition is dissolved in about 2, 3, 4, 5, 6, 7, 8, 9, 10, 11, 12, 13, 14, 15, 16, 17, 18, 19, or 20 ounces of liquid prior to consumption.

In certain embodiments, the liquid into which the cannabinoid formulation is dissolved is itself basic, i.e., it possesses a pH >7.0. In certain embodiments, the liquid into which the cannabis formulation is dissolved comprises a pH of greater than about 7.2, 7.4, 7.5, 7.6, 7.8, 8.0, 8.2, 8.4, 8.5, 8.6, 8.8, 9.0, 9.2, 9.4, 9.5, 9.6, 9.8, or 10.0. In other embodiments, the liquid into which the cannabis formulation is dissolved comprises a pH of about 7.2, 7.4, 7.5, 7.6, 7.8, 8.0, 8.2, 8.4, 8.5, 8.6, 8.8, 9.0, 9.2, 9.4, 9.5, 9.6, 9.8, or 10.0.

In other embodiments, the composition is a liquid composition comprising one or more cannabinoids. In particular embodiments, the liquid composition is basic, i.e., it possesses a pH >7.0. In certain embodiments, the liquid composition comprises a pH of greater than about 7.2, 7.4, 7.5, 7.6, 7.8, 8.0, 8.2, 8.4, 8.5, 8.6, 8.8, 9.0, 9.2, 9.4, 9.5, 9.6, 9.8, or 10.0. In other embodiments, the liquid composition comprises a pH of about 7.2, 7.4, 7.5, 7.6, 7.8, 8.0, 8.2, 8.4, 8.5, 8.6, 8.8, 9.0, 9.2, 9.4, 9.5, 9.6, 9.8, or 10.0. Without being bound by theory, it is believed that the basic pH aids in rapid onset by increasing absorption across the mucous membranes of the mouth, throat, and esophagus.

In certain embodiments, the liquid that is ingested, which can be either a liquid formulation or a solid formulation dissolved in liquid, is held in the subject's mouth for an extended period of time before it is swallowed. By extended period of time, it is meant that the liquid is not simply taken into the mouth and immediately swallowed, as is typically done when drinking a liquid, but rather the liquid is held in the mouth by the subject for a non-negligible period of time before swallowing. In certain embodiments, the liquid can be held in the subject's mouth for a period of about 4 seconds, 5 seconds, 6 seconds, 7 seconds, 8 seconds, 9 seconds, 10 seconds, 11 seconds, 12 seconds, 13 seconds, 14 seconds, 15 seconds, 16 seconds, 17 seconds, 18 seconds, 19 seconds, 20 seconds, 25 seconds, 30 seconds, 35 seconds, 40 seconds, 45 seconds, 50 seconds, 55 seconds, 60 seconds, 1.1 minutes, 1.2 minutes, 1.3 minutes, 1.4 minutes, 1.5 minutes, or longer, prior to being swallowed. In particular embodiments, the liquid is held in the subject's mouth for a period of about 5-60 seconds, 5-55 seconds, 5-50 seconds, 5-45 seconds, 5-40 seconds, 5-35 seconds, 5-30 seconds, 5-25 seconds, 5-20 seconds, 5-15 seconds, 5-10 seconds, 10-60 seconds, 10-55 seconds, 10-50 seconds, 10-45 seconds, 10-40 seconds, 10-35 seconds, 10-30 seconds, 10-25 seconds, 10-20 seconds, 10-15 seconds, 15-60 seconds, 15-55 seconds, 15-50 seconds, 15-45 seconds, 15-40 seconds, 15-35 seconds, 15-30 seconds, 15-25 seconds, 15-20 seconds, 20-60 seconds, 20-55 seconds, 20-50 seconds, 20-45 seconds, 20-40 seconds, 20-35 seconds, 20-30 seconds, 20-25 seconds, 30-60 seconds, 30-55 seconds, 30-50 seconds, 30-45 seconds, 30-40 seconds, 30-35 seconds, 35-60 seconds, 35-55 seconds, 35-50 seconds, 35-45 seconds, 35-40 seconds, 40-60 seconds, 40-55 seconds, 40-50 seconds, 40-45 seconds, 45-60 seconds, 45-55 seconds, 45-50 seconds, 50-60 seconds, 50-55 seconds, or 55-60 seconds prior to being swallowed.

To achieve the desired pH, the composition generally includes an acid component, an alkali (or base) component, or, in many instances, both. Acids and bases suitable for use in this type of composition intended for consumption are well known to persons of ordinary skill in the art, and a person of ordinary skill would be able to select appropriate acid and base components. Additionally, a person of ordinary skill would be able to select appropriate amounts of the acid and base component to provide the particular desired pH.

In certain embodiments, the acid component includes one or more of citric acid, malic acid, tartaric acid, ascorbic acid, fumaric acid, maleic acid, and/or succinic acid. In certain embodiments, the alkali/base component includes one or more of sodium carbonate, sodium bicarbonate, sodium glycine carbonate, calcium carbonate, potassium carbonate, and/or potassium bicarbonate.

In certain particular examples, the composition is a solid composition and it includes one or more of citric acid, malic acid, tartaric acid, ascorbic acid, fumaric acid, maleic acid, and succinic acid and one or more of sodium carbonate, sodium bicarbonate, sodium glycine carbonate, calcium carbonate, potassium carbonate, potassium bicarbonate in amounts calculated to provide a desired pH. In certain examples, the solid composition includes citric acid and/or tartaric acid and also includes sodium carbonate and/or sodium bicarbonate. In other examples, the solid composition includes citric acid and sodium carbonate. In still further examples, the solid composition comprises citric acid and sodium carbonate in a ratio sufficient to provide a pH of 7.5-8.5 upon dissolution in water, preferably 7.75-8.25, more preferable about 8.0.

In additional embodiments, the acid and base component provide for effervescence upon dissolution of the solid composition in a liquid, such as water. Acidic and basic components suitable for use in this type of effervescent composition intended for consumption are well known to persons of ordinary skill in the art, and a person of ordinary skill would be able to select appropriate effervescent agents.

In certain embodiments the composition further comprises one or more additional components, such as flavorants, colorants, sweeteners, vitamins, minerals, and/or oils. Flavorants, colorants, and sweeteners suitable for use in this type of composition intended for consumption are well known to persons of ordinary skill in the art, and a person of ordinary skill would be able to select appropriate flavorant and/or sweetener components.

In certain embodiments, the flavorant may be an essential oil or natural or artificial flavor. Exemplary flavorants include Vanilla extract, Vanillin, Peppermint essence/oil/powder, Lemon essence/oil/powder, orange essence/oil/powder, citrus oil or powder, Berry flavor powder, Strawberry flavor powder, Orange essence, Maltol, Ethyl Maltol, Eucalyptus Oil, Isobutyl Alcohol, Sodium Succinate, Adipic Acid, Almond Oil, Anethole, Benzaldehyde, Denatonium Benzoate, Ethyl Acetate, Ethyl Vanillin, Ethylcellulose, Fructose, Fumaric Acid, l-Glutamic Acid Hydrochloride, Lactitol, Leucine, Malic Acid, Menthol, Methionine, Methyl Salicylate, Monosodium Glutamate, Peppermint Oil, Strawberry flavor, Peppermint Spirit, Racemethionine, Rose Oil, Rose Water, Sodium Acetate, Sodium Lactate Solution, Tartaric Acid, Thymol, Inulin, Isomalt, and/or Neohesperidin Dihydrochalcone.

In certain embodiments, the colorant may be a natural or artificial color. Exemplary colorants include beet juice, fruit juice, red radish extract, Caramel, Ferric Oxide, Titanium Dioxide, Ferrosoferric Oxide, Aluminum Oxide, FD & C Red #40, Amaranth, FD & C Blue #1, Canthaxanthin, Carmine, Carmoisine, Curcumin, FD & C Red #3, Fast Green FCF, Green S, D & C Red #30, FD & C Blue #2, Iron Oxide Black, Iron Oxide Red, D & C Red #7, Patent Blue V, D & C Red #28, Iron Oxide Yellow, D & C Red #27, Ponceau 4R, Quinoline Yellow WS, D & C Yellow #10, Riboflavin, FD & C Yellow #5, FD & C Yellow #6.

In certain embodiments, the sweetener may be a natural or artificial sweetener. Exemplary sweeteners include Sucralose, Saccharin Sodium, Neotame, Acesulfame, Aspartame, Corn Syrup, Dextrates, Dextrose, Erythritol, Fructose, Galactose, Glucose, Glycerin, Inulin, Invert Sugar, Isomalt, Lactitol, Maltitol, Maltose, Mannitol, Saccharin, Sorbitol, Starch Hydrolysate, Sucrose, Tagatose, Trehalose, Xylitol, and/or stevia extract.

The composition may further include additional excipients, including but not limited to one or more diluents (also referred to as bulking agents or fillers), binders, granulating agents, glidants, lubricants, and/or disintegrants. Excipients suitable for use in this type of composition intended for consumption are well known to persons of ordinary skill in the art, and a person of ordinary skill would be able to select appropriate excipients for their particular use.

In certain embodiments, the composition comprises one or more diluents selected from Microcrystalline Cellulose, Powdered Cellulose, Anhydrous Lactose, Lactose Monohydrate, Spray-Dried Lactose, Mannitol, Starch (potato, pea, corn, tapioca, wheat, etc.), Sorbitol, Sucrose, Compressible Sugar, Dextrates, Dextrin, Dextrose, Calcium Phosphate, Maltose, Maltodextrin, Kaolin, Calcium Sulfate, Cellaburate, Calcium Lactate, Cellulose Acetate, Erythritol, Ethylcellulose, Ethyl Acrylate and Methyl Methacrylate Copolymer, Fructose, Isomalt, Alpha-Lactalbumin, Lactitol, Magnesium Carbonate, Magnesium Oxide, Polydextrose, Simethicone, Pullulan, Trehalose, and/or Xylitol.

In certain embodiments, the composition comprises one or more binders selected from Polyvinylpyrrolidone (also referred to as Povidone, Carbomer, Starch, Carboxymethylcellulose Sodium, hydroxypropyl methylcellulose (HPMC), Polyethylene Glycol (PEG), Hydroxyethyl Cellulose, Hydroxypropyl Cellulose, Hydroxyethylmethyl Cellulose, Calcium carboxymethylcellulose, Guar Gum, Ethylcellulose, Chitosan Hydrochloride, Dextrin, Ceratonia, Inulin, Magnesium Aluminum Silicate, Maltodextrin, Methylcellulose, Dextrates, Polyethylene Oxide, Sodium Alginate, Starch, Glucose, Sucrose, Compressible sugar, Zein, Gelatin, Polymethacrylates, Sorbitol, and/or Acacia.

In certain embodiments, the composition comprises one or more disintegrants selected from Crospovidone, Croscarmellose Sodium, Low-Substituted Hydroxypropyl Cellulose, Sodium Starch Glycolate, Chitosan Hydrochloride, Starch, Calcium Alginate, Sodium Alginate, Calcium Sodium Alginate, Docusate Sodium, Microcrystalline Cellulose, Hydroxypropyl Starch, Magnesium Aluminum Silicate, Methylcellulose, Calcium carboxymethylcellulose, Powdered Cellulose.

In certain embodiments, the composition comprises one or more lubricants selected from Magnesium stearate, Magnesium silicate, Calcium stearate, Sodium Lauryl Sulphate, Sodium Stearyl Fumarate, Magnesium Lauryl Sulphate, Stearic Acid, Calcium Stearate, Glyceryl Behenate, Bchenoyl Polyoxylglycerides, Glyceryl Dibchenate, Lauric Acid, Glyceryl Monostearate, Glyceryl Tristearate, Myristic Acid, Palmitic Acid, Poloxamer, Polyethylene Glycol, Polysorbate 20, Polyoxyl 10 Oleyl Ether, Polyoxyl 15 Hydroxystearate, Polysorbate 40, Polyoxyl 20 Cetostearyl Ether, Polyoxyl 40 Stearate, Polysorbate 60 or 80, Potassium Benzoate, Sodium Benzoate, Sorbitan Monolaurate, Sorbitan Monooleate, Sodium Stearate, Sorbitan Monopalmitate, Sorbitan Monostearate, Zinc Stearate, Sorbitan Sesquioleate, Sorbitan Trioleate, and/or Talc.

In certain embodiments, the composition comprises one or more glidants selected from Colloidal Silicon Dioxide, Talc, Tribasic Calcium Phosphate, Calcium Silicate, Powdered Cellulose, Magnesium Oxide, Sodium Stearate, Magnesium Silicate, Silica, Magnesium Trisilicate, and/or Hydrophobic Colloidal Silica.

In certain embodiments, onset of cannabinoid effects following oral ingestion of the formulations will begin in about 30 minutes, 29 minutes, 28 minutes, 27 minutes, 26 minutes, 25 minutes, 24 minutes, 23 minutes, 22 minutes, 21 minutes, 20 minutes, 19 minutes, 18 minutes, 17 minutes, 16 minutes, 15 minutes, 14 minutes, 13 minutes, 12 minutes, 11 minutes, 10 minutes, 9 minutes, 8 minutes, 7 minutes, 6 minutes, 5 minutes, or less. In other embodiments, peak cannabinoid effects will be reached in about 55 minutes, 50 minutes, 45 minutes, 40 minutes, 35 minutes, 30 minutes, 25, minutes, 20 minutes, 19 minutes, 18 minutes, 17 minutes, 16 minutes, 15 minutes, 14 minutes, 13 minutes, 12 minutes, 11 minutes, 10 minutes, 9 minutes, 8 minutes, 7 minutes, 6 minutes, 5 minutes, or less.

Determination of onset and peak times for cannabinoid effects can be by any suitable means. Methods for making such determinations are well known to persons of ordinary skill in the art, and a person of ordinary skill would be able to select appropriate methods. Such methods can include self-reporting of time when effects are felt by the subject or monitoring of relevant physiological characteristics, such as heart rate, blood pressure, respiration rate, and/or brain activity.

In certain embodiments, the formulation, whether liquid or solid, is provided in a kit along with instructions. In certain embodiments, the kit comprises instructions that direct the user to dissolve the solid composition in a given amount of liquid, as described elsewhere herein. In other embodiments, the kit comprises instructions that direct the user to hold the ultimate liquid in the user's mouth for a given period of time prior to swallowing, as described elsewhere herein.

### EXAMPLES

### Example 1—Production of Dissolvable THC Tablets for pH 4, 6, and 8

Solid compositions containing THC were prepared which, when dissolved in water, would provide liquid solutions of differing pH values. Liquid THC distillate at an initial concentration of approximately 868,000 ppm THC was blended with MCT oil to produce a THC oil at a concentration of approximately 243,000 ppm THC. 2.8117 g of the liquid THC distillate was blended with 7.2332 g of the MCT oil to produce 10.0449 g of THC oil at a concentration of approximately 243,000 ppm.

This THC oil was then blended with fine powdered silicon dioxide to plate the THC oil onto the silicon dioxide and create a THC powder material. 5.477 g of the THC oil was blended with 4.755 g of the silicon dioxide powder to produce 10.232 g of THC powder material with a THC concentration of approximately 130,000 ppm, or 130 mg/g.

The THC powder material was then blended with other ingredients to make final tablets that provide a pH of 4, 6, or 8 when dissolved in water. The other ingredients that were utilized in the tableting process were citric acid and/or sodium carbonate (depending on the desired final pH), and powdered NUUN brand hydration tablets. The NUUN brand hydration tablets are commercially available as a water-dissolvable tablet formulation. These tablets were crushed via mortar and pestle to create a base tablet mix, which was then blended with the THC powder material and acid/base components.

The NUUN brand hydration tablets contain the following ingredients in each 5.5 g tablet:
13 mg calcium carbonate
25 mg magnesium oxide
40 mg potassium chloride
300 mg of sodium carbonate/sodium bicarbonate blend
110 mg potassium bicarbonate
Citric acid
Malic acid
Dextrose
Beet powder colorant
Stevia leaf extract
Avocado oil
Natural orange flavor

The tablets that were produced for this study were as follows:

| | target | |
|---|---|---|
| Component | wt % | Quantities (g) |
| NUUN base tablet mix | 88.15% | 33.900 |
| THC powder (130 mg/g) | 6.00% | 2.307 |
| citric acid | 5.85% | 2.250 |
| sodium carbonate | 0.00% | 0.000 |
| Total final mixture | 100.00% | 38.457 |
| weight | | |

Target pH: 4
Batch size: 30 tablets
Number of tablets produced: 30
Final tablet weight: 1.2819
THC per tablet: 10 mg

| | target | |
|---|---|---|
| Component | wt % | Quantities (g) |
| NUUN base tablet mix | 83.28% | 33.9 |
| THC powder (130 mg/g) | 5.67% | 2.307 |
| citric acid | 0.00% | 0 |
| sodium carbonate | 11.05% | 4.5 |
| Total final mixture | 100.00% | 40.7073 |
| weight | | |

Target pH: 6
Batch size: 30 tablets
Number of tablets produced: 30
Final tablet weight: 1.356
THC per tablet: 10 mg

| | target | |
|---|---|---|
| Component | wt % | Quantities (g) |
| NUUN base tablet mix | 66.20% | 33.9 |
| THC powder (130 mg/g) | 4.51% | 2.3073 |
| citric acid | 0.00% | 0 |
| sodium carbonate | 29.29% | 15 |
| Total final mixture | 100.00% | 51.2073 |
| weight | | |

Target pH: 7.5-8.0
Batch size:30 tablets
Number of tablets produced: 30
Final tablet weight: 1.706
THC per tablet: 10 mg

The ingredients were all blended, divided into individual amounts corresponding to 10 mg THC per serving. In this example, 20 powder formulations were prepared and the remaining solid formulation was divided into individual tablet amounts, and pressed into tablet form using manual pressure and a tablet mold. Each type of powder or tablet was dissolved in 4 oz of water and tested using a pH meter and it was determined that each tablet produced the desired pH.

### Example 2—Impact of pH on Onset and Peak Cannabinoid Effects

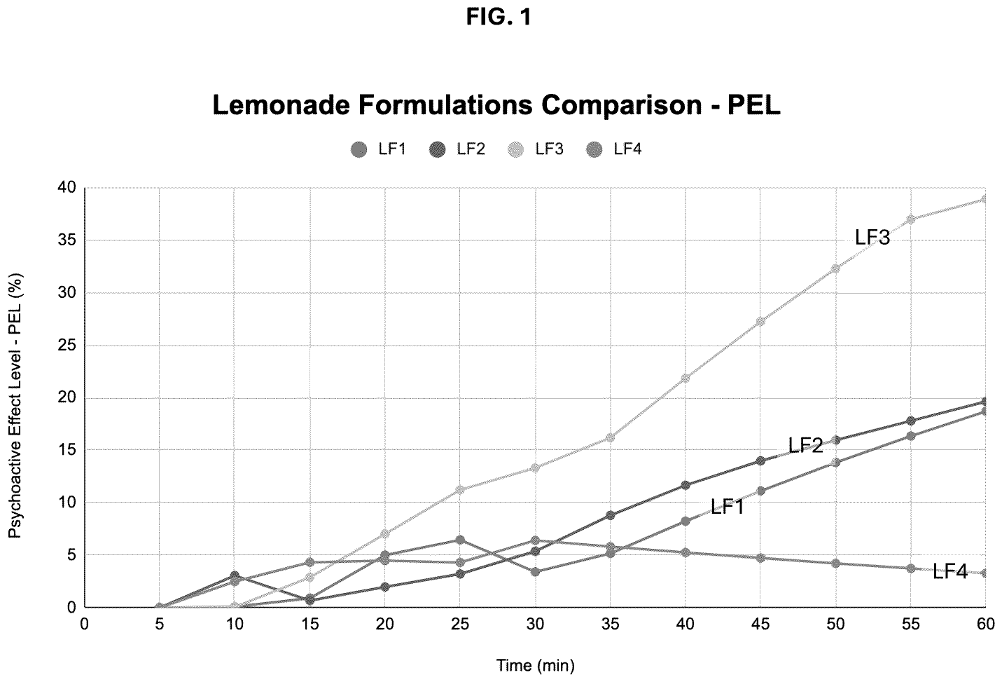

Powder from example 1 was provided to subjects who dissolved the powder in 4 oz water and then consumed the resulting beverage. Subjects were instructed to consume the entire beverage in less than 2 minutes and to consume it in at least 4 sips, holding each sip in the mouth for a few seconds prior to swallowing. Subjects were asked to self-evaluate the extent to which they felt cannabinoid effects every 5 minutes. The results are provided in FIG. 1. LF1 is the pH 4 formulation; LF2 is the pH 6 formulation; LF3 (yellow line) is the pH 8 formulation; and LF4 is a placebo containing no THC.

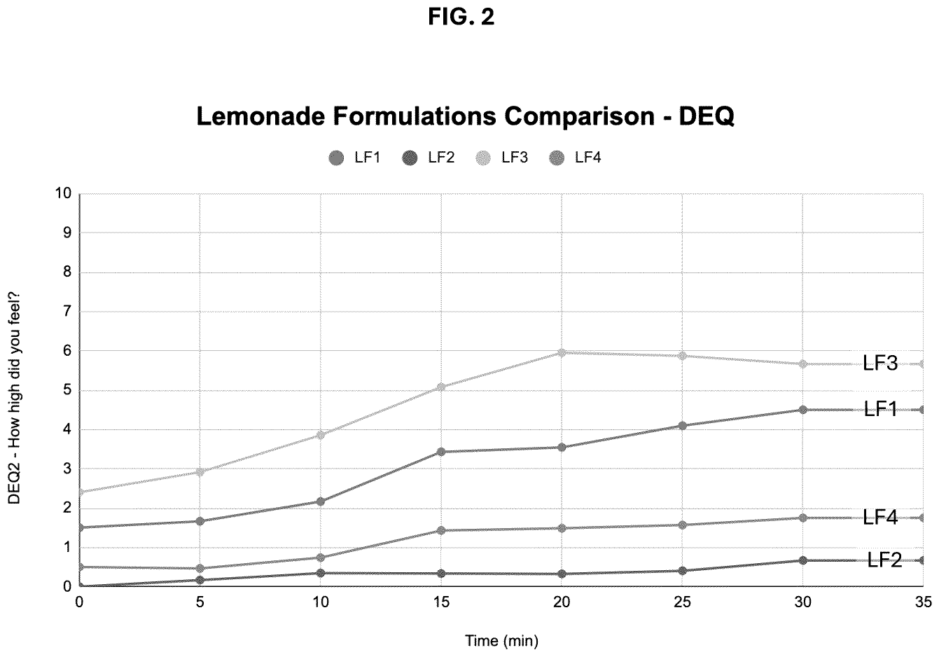

Additionally, physiological cannabinoid effects were measured using an EEG to monitor for known changes in brainwaves during THC intoxication. The results are provided 5 in FIG. 2.

Effects of the pH 8 formulation was found to be most rapid and most intense in both self-reporting and physiological monitoring.

What is claimed is:

1. A solid cannabinoid composition comprising one or more cannabinoids, one or more acids, and one or more bases such that, when dissolved, the composition provides a final pH of at least 7.5.

2. The composition of claim 1, wherein the one or more cannabinoids comprise one or both of THC and CBD.

3. The composition of claim 2, wherein the one or more cannabinoids are each present in an amount of 2-20 mg.

4. The composition of claim 2, wherein the composition further comprises one or more terpenes.

5. The composition of claim 2, wherein the composition further comprises one or more flavorants.

6. The composition of claim 2, wherein the composition further comprises one or more sweeteners.

7. The composition of claim 2, wherein, when dissolved, the solid composition provides, a pH of at least about 8.0.

8. The composition of claim 2, wherein the acid component comprises one or more of citric acid, malic acid, and/or tartaric acid.

9. The composition of claim 2, wherein the base component comprises one or more of sodium carbonate, sodium bicarbonate, potassium carbonate, potassium bicarbonate, and/or calcium carbonate.

10. The composition of claim 2, wherein the one or more cannabinoids are each present in an amount of 2-20 mg;
wherein the composition further comprises one or more terpenes, flavorants, and/or sweeteners;
wherein, when dissolved, the solid composition provides, a pH of at least about 8.0;
wherein the acid component comprises one or more of citric acid, malic acid, and/or tartaric acid; and
wherein the base component comprises one or more of sodium carbonate, sodium bicarbonate, potassium carbonate, potassium bicarbonate, and/or calcium carbonate.

11. A liquid cannabinoid composition prepared by dissolving the composition of claim 2 in a liquid, wherein the liquid is water or a beverage, and wherein the pH of the liquid cannabinoid composition is at least about 7.5.

12. A liquid cannabinoid composition comprising one or more cannabinoids, one or more acids, and one or more bases, wherein the liquid cannabinoid formulation has a pH of at least 7.5.

13. The composition of claim 12, wherein the one or more cannabinoids comprise one or both of THC and CBD.

14. The composition of claim 13, wherein the one or more cannabinoids are each present in an amount of 2-20 mg.

15. The composition of claim 13, wherein the composition further comprises one or more terpenes.

16. The composition of claim 13, wherein the composition further comprises one or more flavorants.

17. The composition of claim 13, wherein the composition further comprises one or more sweeteners.

18. The composition of claim 13, wherein the liquid formulation comprises a pH of at least about 8.0.

19. The composition of claim 13, wherein the acid component comprises one or more of citric acid, malic acid, and/or tartaric acid.

20. The composition of claim 13, wherein the base component comprises one or more of sodium carbonate, sodium bicarbonate, potassium carbonate, potassium bicarbonate, and/or calcium carbonate.

21. The composition of claim 13, wherein the one or more cannabinoids are each present in an amount of 2-20 mg;
wherein the composition further comprises one or more terpenes, flavorants, and/or sweeteners;
wherein, when dissolved, the solid composition provides, a pH of at least about 8.0;
wherein the acid component comprises one or more of citric acid, malic acid, and/or tartaric acid; and
wherein the base component comprises one or more of sodium carbonate, sodium bicarbonate, potassium carbonate, potassium bicarbonate, and/or calcium carbonate.
